(19) United States
(12) Patent Application Publication
(10) Pub. No.: US 2026/0056020 A1
(43) Pub. Date: Feb. 26, 2026

(54) ROUTE PLANNING SYSTEM

(71) Applicant: TOYOTA JIDOSHA KABUSHIKI KAISHA, Toyota-shi (JP)

(72) Inventor: Kazutaka KIMURA, Mishima-shi (JP)

(73) Assignee: TOYOTA JIDOSHA KABUSHIKI KAISHA, Toyota-shi (JP)

(21) Appl. No.: 19/284,163

(22) Filed: Jul. 29, 2025

(30) Foreign Application Priority Data
Aug. 26, 2024 (JP) 2024-144335

(51) Int. Cl. G01C 21/20; G01W 1/10

(52) U.S. Cl. CPC G01C 21/203; G01W 1/10

(57) ABSTRACT

A route planning system is a route planning system for planning a route for a power-generating floating body that generates electricity while sailing on the sea. The route planning system comprises a planner configured to plan a route for the power-generating floating body circulating between a meeting point, at which a transport ship collecting energy from the power-generating floating body, meets the power-generating floating body and a turning point different from the meeting point as the route. The planner changes number of laps the power generation floating body circulates the route before meeting with the transport ship on the basis of at least one of weather forecasts accuracy and sea condition forecasts accuracy.

### CROSS-REFERENCE TO RELATED APPLICATIONS

This application is based upon and claims the benefit of priority of the prior Japanese Patent Application No. 2024-144335, filed on Aug. 26, 2024, the entire contents of which are incorporated herein by reference.

### BACKGROUND

### 1. Technical Field

Embodiments of the present disclosure relate to the technical field of a route planning system.

### 2. Description of the Related Art

As a technology used in this type of system, for example, a technology has been proposed that selects a route with the shortest operating time from among a plurality of routes based on weather and sea conditions and ship speed (refer to JP5953219B (Patent Literature 1)).

The technology described in Patent Literature 1 does not consider collecting electrical energy from a power-generating floating body that generates electricity while sailing at sea.

### SUMMARY

In view of the aforementioned problems, it is therefore an object of embodiments of the present disclosure to provide a route planning system that can improve operational efficiency of a power-generating floating body.

One aspect of a route planning system according to the present disclosure is a route planning system for planning a route for a power-generating floating body that generates electricity while sailing on the sea, wherein the route planning system comprising a planner configured to plan a route for the power-generating floating body circulating between a meeting point, at which a transport ship collecting energy from the power-generating floating body, meets the power-generating floating body and a turning point different from the meeting point as the route, wherein the planner changes number of laps the power generation floating body circulates the route before meeting with the transport ship on the basis of at least one of weather forecasts accuracy and sea condition forecasts accuracy.

### BRIEF DESCRIPTION OF THE DRAWINGS

FIG. 1 is a conceptual diagram showing a power generation system according to an embodiment.

FIG. 2A is a diagram showing an example of a floating body according to the embodiment.

FIG. 2B is a diagram showing an example of a floating body according to the embodiment.

FIG. 3 is a block diagram showing configuration of a route planning system according to the embodiment.

FIG. 4 is a conceptual diagram for explaining the meeting point adjustment operation.

FIG. 5 is a diagram showing an example of a route.

### DETAILED DESCRIPTION OF THE EMBODIMENTS

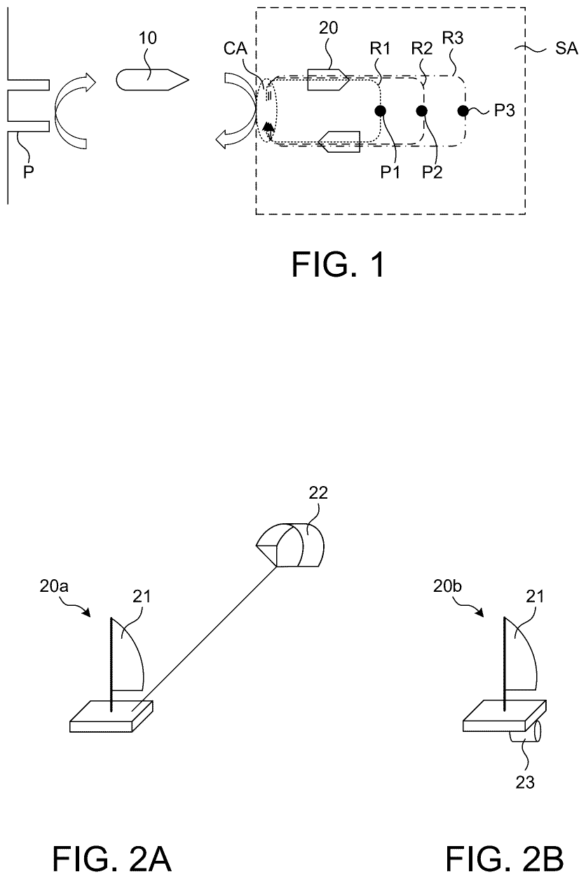

An embodiment of a route planning system will be described with reference to FIG. 1 to FIG. 5

### Configuration of Power Generation System

Configuration of a power generation system will be described with reference to FIG. 1 and FIG. 2. In the power generation system according to this embodiment, power is generated using a plurality of floating bodies 20 that do not require mooring in a sea area SA relatively far from land. The plurality of floating bodies 20 automatically sail within the sea area SA. In other words, each of the plurality of floating bodies 20 generates power while automatically sailing within the sea area SA. For example, the sea area SA may be a sea area located 50 kilometers away from land. As shown in FIG. 1, the plurality of floating bodies 20 form a formation. By forming a formation, interference between the floating bodies 20 can be suppressed. As a result, a decrease in the power generation efficiency of one floating body 20 caused by other floating bodies 20 can be suppressed.

The floating body 20 will be described with reference to FIG. 2. In FIG. 2A, the floating body 20a, as a floating body 20, is provided with a sail 21 and a kite 22. The floating body 20a may utilize the wind energy received by the sail 21 as propulsion force. In the floating body 20a, as the kite 22 rises, the tether securing the kite 22 is released from a winch (not shown). The rotation of the winch drum is caused by the unwinding of the tether. As the drum rotates, a generator (not shown) rotates, thereby generating electricity. When the tether is unwound to a predetermined length or a predetermined time has elapsed, the motor of the winch rotates the drum in the direction of winding the tether. As a result, the kite 22 descends due to the retraction of the tether. In the floating body 20a, electricity generation occurs through the repeated release and retraction of the tether. In other words, tether-type wind power generation is performed in the floating body 20a. Additionally, the floating body 20a may utilize the wind energy received by the kite 22 as propulsion power.

In FIG. 2B, the floating body 20b, as the floating body 20, is provided with a sail 21 and an underwater turbine generator 23. The floating body 20b may utilize the wind energy received by the sail 21 as propulsive force. As the floating body 20b moves, seawater flows into the underwater turbine generator 23. As a result, electricity is generated in the underwater turbine generator 23.

Incidentally, the floating body 20a may also be provided with an underwater turbine generator 23. In other words, the floating body 20a may perform electricity generation using the underwater turbine generator 23 in addition to tethered wind power generation. Similarly, the floating body 20b may be provided with a kite 22. In other words, the floating body 20b may perform tethered wind power generation in addition to power generation using the underwater turbine generator 23.

The floating body 20 may store the electrical power obtained through power generation in a battery (e.g., a lithium-ion battery). In other words, the floating body 20 may store electrical energy as electrical energy. The floating body 20 may generate hydrogen by electrolysis of water using electricity generated by power generation. The floating body 20 may store the generated hydrogen. In other words, the floating body 20 may store electrical energy as hydrogen energy. Furthermore, hydrogen may be stored by compression or by being absorbed into a hydrogen storage alloy. Incidentally, the floating body 20 may use the generated hydrogen to produce ammonia. The floating body 20 may store the produced ammonia. In other words, the floating body 20 may store electrical energy as ammonia energy.

Returning to FIG. 1, the transport ship 10 sails between the port P located on land and the sea area SA. For example, the transport ship 10 may collect energy from the plurality of floating bodies 20 in the area CA on the port P side of the sea area SA. For example, if the floating bodies 20 have stored energy in batteries, the transport ship 10 may collect the charged batteries from the floating body 20. At this time, the transport ship 10 may install uncharged batteries on the floating body 20. In other words, the transport ship 10 may perform battery replacement in the area CA. For example, if the floating bodies 20 store energy by compressing and storing hydrogen in hydrogen tanks, the transport ship 10 may collect the hydrogen tanks containing hydrogen from the floating bodies 20. At this time, the transport ship 10 may install empty hydrogen tank on the floating body 20. In other words, the transport ship 10 may perform hydrogen tank transfer operations in the area CA. Incidentally, the area CA is an area where the transport ship 10 and the floating body 20 can converge, and where the route of the floating body 20 is not affected by the transport ship 10.

### Route Planning System

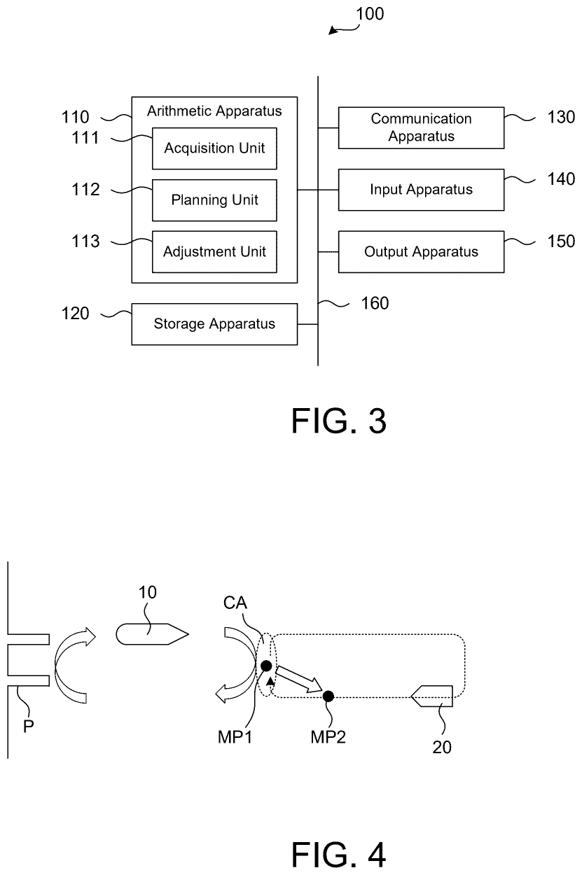

Next, the route planning system 100 for planning the route of the floating body 20 will be described with reference to FIG. 3. In FIG. 3, the route planning system 100 includes an arithmetic apparatus 110, a storage apparatus 120, a communication apparatus 130, an input apparatus 140, and an output apparatus 150. The arithmetic apparatus 110, the storage apparatus 120, the communication apparatus 130, the input apparatus 140, and the output apparatus 150 may be connected via a data bus 160. Incidentally, the route planning system 100 may not necessarily include at least one of the input apparatus 140 and the output apparatus 150.

The arithmetic apparatus 110 may include, for example, at least one of a CPU (central processing unit) and a GPU (graphics processing unit). In other words, the arithmetic apparatus 110 may include a processor.

The storage apparatus 120 may include, for example, a RAM (Random Access Memory), a ROM (Read Only Memory), a hard disk device, an optical magnetic disk device, an SSD (Solid State Drive), and an optical disk array.

The communication apparatus 130 may be capable of communicating with apparatus external to the route planning system 100. An apparatus installed on the transport vessel 10 and apparatus installed on each of the plurality of floating bodies 20 are cited as examples of apparatus external to the route planning system 100. The communication apparatus 130 may perform wired communication or wireless communication.

The input apparatus 140 is an apparatus capable of receiving information input from outside the route planning system 100. The input apparatus 140 may include an operation apparatus (e.g., a keyboard, a mouse, a touch panel, etc.) operable by a user (e.g., an operator) of the route planning system 100. The input apparatus 140 may include a recording medium reading device capable of reading information recorded on a recording medium that can be attached to and detached from the route planning system 100, such as a USB (Universal Serial Bus) memory. When information is input to the route planning system 100 via the communication apparatus 130 (in other words, when the route planning system 100 acquires information via the communication apparatus 130), the communication apparatus 130 may function as an input apparatus.

The output apparatus 150 is an apparatus capable of outputting information to the outside of the route planning system 100. The output apparatus 150 may output visual information such as characters and images, auditory information such as voice, or tactile information such as vibration as the above information. The output apparatus 150 may include, for example, at least one of a display, a speaker, a printer, and a vibration motor. The output apparatus 150 may be capable of outputting information to a recording medium that is detachable from the route planning system 100, such as a USB memory. When the route planning system 100 outputs information via the communication apparatus 130, the communication apparatus 130 may function as an output apparatus.

The storage apparatus 120 is capable of storing desired data. The storage apparatus 120 may store a computer program executed by the arithmetic apparatus 110. The storage apparatus 120 may temporarily store data temporarily used by the arithmetic apparatus 110 when the arithmetic apparatus 110 is executing the computer program.

Incidentally, the computer program may be recorded on a recording medium that is readable by a computer and is not temporary. In this case, the route planning system 100 may read the computer program from the recording medium using a recording medium reading device. The recording medium may be at least one of an optical disk, a magnetic medium, an optical magnetic disk, a semiconductor memory, and any other medium capable of storing a program. The route planning system 100 may acquire a computer program from an external apparatus not shown via the communication apparatus 130.

For example, the arithmetic apparatus 110 may execute a computer program stored in the storage apparatus 120 to realize logical function blocks for executing processing to be performed by the route planning system 100 within the arithmetic apparatus 110.

The arithmetic apparatus 110 may have an acquisition unit 111, a planning unit 112, and an adjustment unit 113 as function blocks realized logically or as processing circuits realized physically. Incidentally, at least one of the acquisition unit 111, the planning unit 112, and the adjustment unit 113 may be realized in a form that mixes logical functional blocks and physical processing circuits (i.e., hardware).

The acquisition unit 111 may acquire weather information and sea condition information of the sea area where the transport ship 10 sails, and weather information and sea condition information of the sea area SA where the plurality of floating bodies 20 generate electricity. For example, the acquisition unit 111 may acquire at least one of the weather information and the sea condition information from a public institution (e.g., the Meteorological Agency, the Japan Coast Guard, etc.) via the communication apparatus 130. For example, when a measurement apparatus is installed on at least one of the transport ship 10 and the floating bodies 20, the acquisition unit 111 may acquire at least one of the weather information and the sea condition information from at least one of the transport ship 10 and the floating bodies 20 via the communication apparatus 130. Incidentally, the acquisition unit 111 may not acquire at least one of the weather information and sea condition information for the sea area where the transport ship 10 is sailing. Furthermore, the acquisition unit 111 may not acquire one of the weather information and sea condition information for the sea area SA.

The planning unit 112 plans a route for the floating body 20, which is a route that the floating body 20 circulates between a meeting point (e.g., a position within the area CA) between the floating body 20 and the transport ship 10 and a turnaround point (refer to the symbols “P1,”“P2,”and “P3”in FIG. 1).

When the floating body 20 is a floating body 20a or 20b having a sail 21 as shown in FIG. 2A or 2B, the speed of the floating body 20 is greatest when the wind blows perpendicular to the direction of travel of the floating body 20. For example, the planning unit 112 may determine the direction in which the straight line connecting the meeting point and the turning point extends (in other words, the direction of travel of the floating body 20) so that the direction of the straight line is substantially perpendicular to the wind direction based on the wind direction indicated by the weather information in the sea area SA.

For example, the planning unit 112 may determine the direction in which the straight line extending between the meeting point and the turning point extends such that the direction of the straight line aligns with the direction of the sea current based on the sea current direction indicated by sea condition information in the sea area SA. For example, the planning unit 112 may determine the direction in which the straight line extending between the meeting point and the turning point extends based on both weather information and sea condition information. Incidentally, determining the direction in which the straight line connecting the meeting point and the turning point extends may also be referred to as determining the direction of movement of the floating body 20. For example, the planning department 112 may determine the meeting point based on the route of the transport ship 10.

For example, the planning unit 112 may predict the power generation of the floating body 20 based on at least one of the wind speed indicated by the weather information and the sea current speed indicated by the sea condition information. At this time, the planning unit 112 may predict at least one of the future weather and the future sea conditions based on at least one of the weather information and the sea condition information. In other words, the planning unit 112 may perform at least one of the weather prediction and the sea condition prediction. For example, the planning unit 12 may predict the time until the battery pack installed on the floating body 20 reaches a fully charged state as the power generation prediction for the floating body 20. For example, the planning unit 112 may predict the time until the hydrogen tank installed on the floating body 20 reaches a full state as the power generation prediction for the floating body 20.

For example, from the perspective of the operational efficiency of the power generation system, it can be said that efficiency is good when the floating body 20 and the transport ship 10 meet (in other words, when the transport ship 10 collects energy from the floating body 20) at the timing when the battery is fully charged or when the hydrogen tank is full. Therefore, the planning unit 112 may determine the rendezvous time between the floating body 20 and the transport ship 10 based on the power generation prediction for the floating body 20.

For example, the planning unit 112 may determine the turnaround point such that the floating body 20 reaches the rendezvous point at the rendezvous time. At this time, the planning unit 112 determines the turnaround point based on the direction in which the straight line connecting the rendezvous point and the turnaround point extends (in other words, the direction of movement of the floating body 20) and the rendezvous point. The planning unit 112 may determine the route of the floating body 20 that circulates between the rendezvous point and the turnaround point using the method described above.

In this embodiment, the planning unit 112 changes the number of times the floating body 20 circulates the above course based on at least one of the weather forecast accuracy and the sea condition forecast accuracy. For example, the planning unit 112 may change the turning point so that the number of times the floating body 20 circulates the above course changes based on at least one of the weather forecast accuracy and the sea condition forecast accuracy.

Incidentally, the weather forecast accuracy and the sea condition forecast accuracy are indicators of the reliability of forecasts. The higher the weather forecast accuracy, the more likely the weather forecast is to be accurate. Similarly, the higher the sea condition forecast accuracy, the more likely the sea condition forecast is to be accurate. For example, the greater the difference between the current time and the forecast time, the lower the accuracy may be. For example, the more the pressure pattern resembles a typical pressure pattern, the higher the weather forecast accuracy may be. For example, if there is a high probability that a front will pass through sea area SA, the weather forecast accuracy may be lower than when the front does not pass through sea area SA.

When either the weather forecast accuracy or the sea condition forecast accuracy is low, the probability that the power generation forecast for floating body 20 will be inaccurate is higher than when both the weather forecast accuracy and the sea condition forecast accuracy are high. When the power generation prediction for the floating body 20 is inaccurate, there is a possibility that the floating body 20 will meet the transport ship 10 in a state where it does not have sufficient energy stored (e.g., the battery is not fully charged, or the hydrogen tank is not full). Alternatively, when the power generation prediction for the floating body 20 is inaccurate, there may be a relatively long period of time until the rendezvous time with the transport vessel 10, even when the floating body 20 has sufficient energy stored. In this way, when the power generation prediction for the floating body 20 is inaccurate, the operational efficiency of the power generation system may decrease.

For example, assume that the sea condition prediction accuracy is constant. When the weather forecast accuracy is relatively low, the planning unit 112 may set point P1 in FIG. 1 as the turnaround point. In this case, the floating body 20 may sail along route R1. When the weather forecast accuracy is relatively high, the planning unit 12 may set point P3 in FIG. 1 as the turnaround point. In this case, the floating body 20 may sail along route R3. When the weather forecast accuracy is moderate, the planning department 12 may set point P2 in FIG. 1 as the turning point. In this case, the floating body 20 may sail along route R2.

As shown in FIG. 1, the route length of route R1 is shorter than the route length of route R2. Furthermore, the route length of route R2 is shorter than that of route R3. Therefore, when the time required for the floating body 20 to accumulate sufficient energy is constant, the number of times the floating body 20 circles route R1 is greater than the number of times it circles route R3. Therefore, the planning department 12 can increase the number of times the floating body 20 circulates the route compared to when both weather prediction accuracy and sea condition prediction accuracy are high, when at least one of weather prediction accuracy and sea condition prediction accuracy is low.

When at least one of weather prediction accuracy and sea condition prediction accuracy is low, a route with a shorter route length can be set compared to when both weather prediction accuracy and sea condition prediction accuracy are high. By configuring the system in this manner, even when the power generation forecast is inaccurate, the timing of the rendezvous between the floating body 20 and the transport ship 10 can be adjusted to an appropriate timing by increasing or decreasing the number of times the floating body 20 circles the route.

However, as described above, simply changing the number of laps may not be sufficient to adequately adjust the timing of the rendezvous between the floating body 20 and the transport ship 10. Therefore, the adjustment unit 113 may adjust the meeting point and the time at which the floating body 20 and the transport ship 10 meet (corresponding to the aforementioned meeting time) when the energy stored in the floating body 20 reaches the upper limit before the floating body 20 meets the transport ship 10. “The energy stored in the floating body 20 reaches the upper limit” may mean, for example, that the battery is fully charged or that the hydrogen tank is full.

For example, the adjustment unit 113 may predict the time when the transport ship 10 reaches the initial meeting point (e.g., point MP1 in FIG. 4) based on at least one of the weather information and sea condition information. The adjustment unit 113 may determine the distance from the current position of the floating body 20 to the initial meeting point based on the position of the floating body 20. The adjustment unit 113 may further predict the time at which the floating body 20 will reach the initial meeting point based on the speed of the floating body 20.

The adjustment unit 113 may compare the time at which the transport ship 10 reaches the initial meeting point with the time at which the floating body 20 reaches the initial meeting point. The adjustment unit 113 may determine whether it is necessary to adjust the meeting point based on the comparison result. For example, the adjustment unit 113 may determine that it is necessary to adjust the rendezvous point if the time when the floating body 20 reaches the initial rendezvous point is later than the time when the transport ship 10 reaches the initial rendezvous point by a predetermined time or more.

When it is determined that it is necessary to adjust the rendezvous point, the adjustment unit 113 may change (i.e., adjust) the rendezvous point to a position closer to the floating body 20 than the initial rendezvous point. For example, the adjustment unit 113 may change the point MP1 (i.e., an example of the initial meeting point) in FIG. 4 to point MP2. Thereafter, the adjustment unit 113 may set (i.e., adjust) the meeting time at which the floating body 20 and the transport ship 10 meet at the new meeting point (e.g., point MP2 in FIG. 4). In this way, even when the power generation prediction is inaccurate, the timing of the rendezvous between the floating body 20 and the transport ship 10 can be adjusted to an appropriate timing by adjusting the rendezvous point and rendezvous time. Incidentally, the route planning system 100 may not include an adjustment unit 113. In other words, the adjustment of the rendezvous point described above may not be performed.

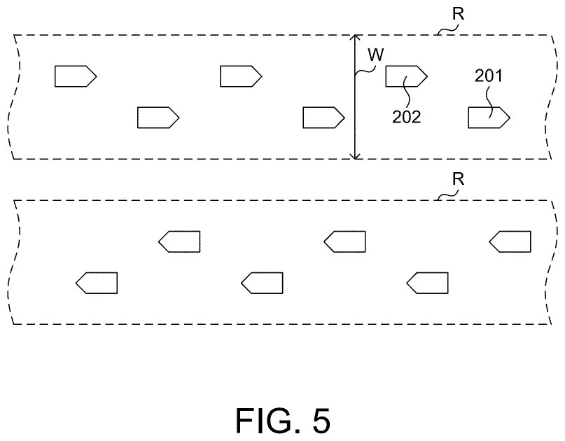

The route in which the floating body 20 sails will be father described with reference to FIG. 5. In the power generation system, plurality of floating bodies 20 may form a formation. The plurality of floating bodies 20 may sail a single route (refer to route R in FIG. 5). In other words, the plurality of floating bodies 20 may share a single route. In this case, the width W of route R may be adjusted according to the number of floating bodies 20 sailing route R. In other words, the more floating bodies 20 traveling along route R, the wider the width W can be.

For example, the planning unit 112 does not need to set the same turnaround point for plurality of floating bodies 20 traveling along route R. In other words, planning unit 112 may set a turnaround point for each floating body 20.

For example, wind direction and wind speed change over time. Therefore, the energy stored in floating body 202 shown in FIG. 5 may reach the upper limit faster than the energy stored in floating body 201. In this case, the planning unit 112 may set the turning point of floating body 202 so that the floating body 202 reaches the meeting point faster than the floating body 201. In this way, the planning unit 112 may change the order in which each floating body 20 reaches the meeting point according to the amount of energy stored in each floating body 20. Furthermore, if the energy stored in the floating body 202 is greater than the energy stored in floating body 201, the route planning system 100 may suppress the power generation of the floating body 202 so that the energy stored in the floating body 201 becomes greater than the energy stored in the floating body 202. By configuring the system in this manner, the amount of energy stored in each of the floating bodies 201 and 202 can be adjusted to correspond to the sailing order of the floating bodies 201 and 202.

### Technical Effect

In the route planning system 100, the turning point is changed based on at least one of the weather forecast accuracy and the sea condition forecast accuracy. In other words, in the route planning system 100, the number of laps is changed based on at least one of the weather forecast accuracy and the sea condition forecast accuracy. In addition, in the route planning system 100, the meeting point and the meeting time are adjusted.

Therefore, according to the route planning system 100, even if the power generation forecast is inaccurate, the timing of the rendezvous between the floating body 20 and the transport ship 10 can be relatively easily adjusted. As a result, in the route planning system 100, the transport ship 10 can efficiently collect power generation energy from the floating body 20. Therefore, according to the route planning system 100, the operational efficiency of the floating body 20 can be improved.

The aspects of the invention derived from the embodiments described above will be described below.

A route planning system of one aspect of the invention is a route planning system for planning a route for a power-generating floating body that generates electricity while sailing on the sea, wherein the route planning system comprising a planner configured to plan a route for the power-generating floating body circulating between a meeting point, at which a transport ship collecting energy from the power-generating floating body, meets the power-generating floating body and a turning point different from the meeting point as the route, wherein the planner changes number of laps the power generation floating body circulates the route before meeting with the transport ship on the basis of at least one of weather forecasts accuracy and sea condition forecasts accuracy.

In the above embodiment, the “floating body 20” corresponds to an example of a “power-generating floating body,” and the “planning unit 112” corresponds to an example of “planner.”

The route planning system may be provided with an adjuster configured to adjust the meeting point and time at which the power-generating floating body and the transport ship meet when energy stored in the power-generating floating body reaches an upper limit before the power-generating floating body meets the transport ship. In the above embodiment, the “adjustment unit 113” corresponds to an example of the “adjuster.”

In the route planning system, the planner may increase the number of laps compared to when both the weather forecast accuracy and the sea condition forecast accuracy are high, when at least one of the weather forecast accuracy and the sea condition forecast accuracy is low.

In the route planning system, the planner may change the turning point so that the number of laps changes on the basis of at least one of the weather forecast accuracy and the sea condition forecast accuracy.

The present invention is not limited to the above-described embodiments. The present invention may be modified as appropriate within the scope of the invention as described in the claims and the entire description. A route planning system with such modifications is also included in the scope of the present invention.

What is claimed is:

1. A route planning system for planning a route for a power-generating floating body that generates electricity while sailing on the sea, the route planning system comprising a planner configured to plan a route for the power-generating floating body circulating between a meeting point, at which a transport ship collecting energy from the power-generating floating body, meets the power-generating floating body and a turning point different from the meeting point as the route,
wherein the planner changes number of laps the power generation floating body circulates the route before meeting with the transport ship on the basis of at least one of weather forecasts accuracy and sea condition forecasts accuracy.

2. The route planning system according to claim 1, wherein
the route planning system comprises an adjuster configured to adjust the meeting point and time at which the power-generating floating body and the transport ship meet when energy stored in the power-generating floating body reaches an upper limit before the power-generating floating body meets the transport ship.

3. The route planning system according to claim 1, wherein
the planner increases the number of laps compared to when both the weather forecast accuracy and the sea condition forecast accuracy are high, when at least one of the weather forecast accuracy and the sea condition forecast accuracy is low.

4. The route planning system according to claim 1, wherein
the planner changes the turning point so that the number of laps changes on the basis of at least one of the weather forecast accuracy and the sea condition forecast accuracy.
